(19) United States
(12) Patent Application Publication
(10) Pub. No.: US 2025/0035377 A1
(43) Pub. Date: Jan. 30, 2025

(54) A 3D printing consumables drying machine

(71) Applicant: Shenzhen EIBOS Chuanggou Tech Co., Ltd., Shenzhen (CN)

(72) Inventor: Dezhen Chen, Shenzhen (CN)

(21) Appl. No.: 18/766,178

(22) Filed: Jul. 8, 2024

(30) Foreign Application Priority Data
Jul. 27, 2023 (CN) 202321999455.X

(51) Int. Cl. F26B 13/14; B29B 13/06; B29C 64/314; B33Y 40/10; F26B 21/08; F26B 21/10; F26B 25/10

(52) U.S. Cl. CPC F26B 13/14; B29B 13/06; B29C 64/314; B33Y 40/10; F26B 21/08; F26B 21/10; F26B 25/10

(57) ABSTRACT

A 3D printing consumables drying machine is disclosed. The top of the base is provided with a accommodation cavity. The rolling mechanism, heating mechanism and drive mechanism are installed in the accommodating cavity. The rolling mechanism is used to carry the reel. The heating mechanism is installed in the accommodating cavity. The driving mechanism is installed in the accommodating cavity. The driving mechanism is used to drive the rolling mechanism to rotate and to drive the reel on the rolling mechanism to rotate. The problem with many 3D printing consumables dryers on the market is that the internal reel remains static during drying. This causes uneven heating of the consumables. Which resulting in inconsistent drying across the consumables. Moreover, the consumables close to the heating device are prone to deformation, melting, and other undesirable effects due to excessive heat.

### FIELD OF THE INVENTION

The present application relates to drying machines. More specifically, the present application relates to a 3D printing consumables drying machine.

### BACKGROUND

Fused Deposition Modeling (FDM), the most popular 3D printing process, uses high-molecular thermoplastic materials wound in a reel as consumables. These materials are prone to absorbing moisture from the air, which increases their internal water content. When heated during the 3D printing process, the water molecules inside the consumables vaporize, forming bubbles that can affect the appearance and strength of the printed object. Additionally, damp consumables can become brittle, reducing their effectiveness. Therefore, it is essential to dry the consumables in a dryer before 3D printing.

The current 3D printing consumables dryer on the market has an internal reel that is usually static during the drying process. This can result in uneven heating of the consumables. The temperature near the heating device is higher, while the temperature farther away is lower, leading to inconsistent drying of different parts of the consumables on the reel. Additionally, the consumables near the heating device are prone to deformation, melting, and other undesirable effects due to excessive heat.

### SUMMARY

In light of the aforementioned issues, the purpose of this innovation is to propose a 3D printing consumables dryer that addresses the problem of uneven heating in the internal reel of current 3D printing consumables dryers. In the existing models, the reel is typically stationary during the drying process, leading to uneven heating of the consumables. As a result, the area near the heating device becomes excessively hot while the outer areas remain relatively cooler, causing inconsistent drying of the consumables on the reel. Furthermore, the consumables near the heating device are prone to deformation, melting, and other undesirable effects due to the uneven heating.

For this situation, an improved 3D printing consumables drying machine is desirable:

A 3D printing consumables drying machine, comprising a base, a rolling mechanism, a heating mechanism, an upper cover, a drive mechanism and a reel.

Wherein The top of the base is provided with a accommodation cavity. Wherein the accommodation cavity is provided with a clapboard.

Wherein the rolling mechanism is installed in the accommodating cavity. The rolling mechanism is used to carry the reel.

Wherein the heating mechanism is installed in the accommodating cavity. Wherein the heating mechanism is used to heat and dry the consumables on the reel.

Wherein the driving mechanism is installed in the accommodating cavity. Wherein the driving mechanism is used to drive the rolling mechanism to rotate and to drive the reel on the rolling mechanism to rotate.

Wherein the top of the base is provided with an upper cover. The bottom surface of the upper cover is open. The rolling mechanism, the heating mechanism and the driving mechanism are all located directly below the upper cover.

In an embodiment, the rolling mechanism, comprising a first roller set. Wherein the first roller set, comprising a first roller and a second roller in the accommodation cavity. Wherein the first roller and the second roller are arranged parallel to and spaced apart from each other.

Wherein the drive mechanism, comprising a drive component. Wherein the driving component is installed at the bottom end of the accommodating cavity. Wherein the output end of the driving component is connected to a first bevel gear. Wherein the upper portion of the first bevel gear is meshedly connected with a second bevel gear. Wherein the second bevel gear is coaxially connected to a rotating shaft. Wherein cams are fixedly connected at both ends of the rotating shaft. Wherein the outer circumference of the cam is fixedly sleeved with an anti-slip ring. Wherein the raised ends of the two anti-slip rings are in contact with the outer surface of the first roller.

In an embodiment, the rolling mechanism, comprising a second roller set. Wherein the second roller set, comprising a third roller and a fourth roller rotatably disposed in the accommodating cavity. Wherein the axes of the third roller and the first roller are located on the same straight line. Wherein axes of the fourth roller and the second roller are located on the same straight line.

Wherein the protruding ends of the two anti-slip rings are in contact with the outer surfaces of the first roller and the third roller respectively.

In an embodiment, the end of the third roller and the first roller that is away from each other and the end of the fourth roller and the second roller that is away from each other are both rotatably connected to a first bearing seat. Wherein the first bearing base is fixedly mounted on the side wall of the accommodating cavity. Wherein the third roller and the first roller, which are adjacent to each other, and the fourth roller and the second roller, which are also adjacent to each other, are both connected to a second bearing seat in a way that allows them to rotate. Wherein the outer surfaces of each of the two adjacent second bearing bases are fixedly sleeved with a fixing base. Wherein the fixing base is fixedly mounted on the clapboard. Wherein the rotating shaft is disposed through the fixed base and is rotatably connected to the fixed base.

In an embodiment, the outer circumference of the cam is provided with a groove. Wherein the anti-slip ring is embedded in the groove.

In an embodiment, the top of the clapboard is provided with a temperature sensor and a humidity sensor. Wherein the side wall of the base is provided with a control panel. Wherein the control panel is connected to the driving component via a wire. Wherein the temperature sensor and the humidity sensor are electrically connected.

In an embodiment, the surface of the clapboard is provided with a desiccant tank and a through hole. Wherein the driving mechanism is located in the through hole.

In an embodiment, the top of the upper cover and the side wall of the base are both provided with a outlet hole. Wherein the top of the upper cover is also provided with an exhaust vent.

In an embodiment, the upper cover is transparent or translucent. Wherein a handle is provided at the top of the upper cover.

In an embodiment, the bottom of the base is provided with anti-slip pads around the periphery.

The technical solution provided by this application may include the following beneficial effects:
1. This method utilizes a driving mechanism to rotate the rolling mechanism, which in turn rotates the reel on the rolling mechanism. This ensures that the consumables on the reel are evenly heated during the drying process, thus preventing uneven heating and local overheating.
2. The temperature and humidity inside the device can be monitored in real-time using the temperature and humidity sensors, and the readings can be displayed on the control panel. The control panel allows for controlling the rotation of the reel and setting parameters such as baking temperature, drying time, and heating power to make it easier for users to operate.

### BRIEF DESCRIPTION OF THE DRAWINGS

The technology may be more completely understood in connection with the following drawings, in which:

FIG. 1 is a perspective view of a compound bow riser and a bow cam, according to an embodiment;

FIG. 2 is a schematic diagram of the structure of the reel placed on the base;

FIG. 3 is a perspective view of a base, according to an embodiment;

FIG. 4 is a perspective view of a drive mechanism, according to an embodiment;

FIG. 5 is a perspective view of a cam, according to an embodiment;

FIG. 6 is a perspective view of a upper cover, according to an embodiment.

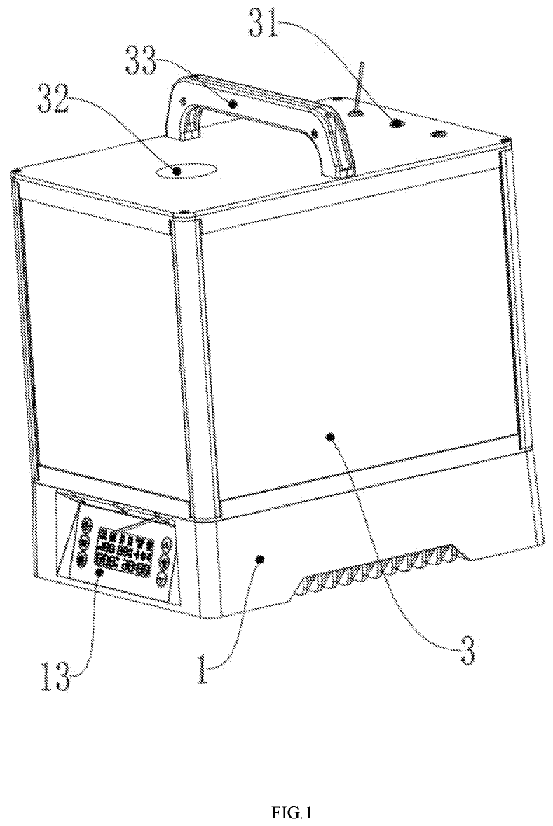

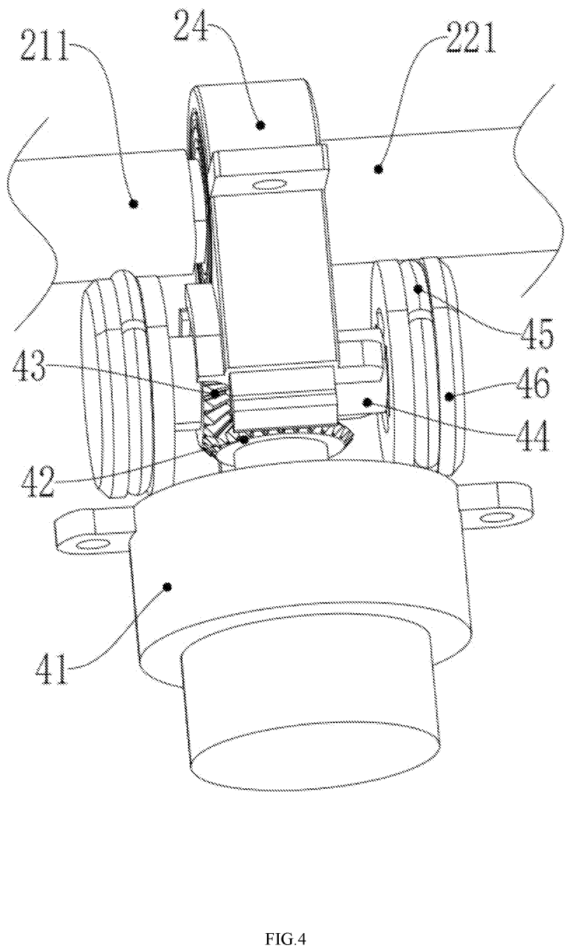

As show in FIGS. 1-6:
1. Base
11. Accommodation cavity
12. Clapboard
121. Desiccant tank
13. Control Panel
2. Rolling mechanism
21. First roller set
211. First roller
212. Second roller
22. Second roller set
221. Third roller
222. Fourth roller
23. First bearing base
24. Fixed base
3. Upper cover
31. outlet hole
32. Exhaust vent
33. Handle
4. Drive mechanism
41. Drive Component
42. First bevel gear
43. Second bevel gear
44. Rotating Shaft
45. Anti-slip ring
46. Cam
461. Groove
5. Reel

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Within this application, terms such as “longitudinal”, “transverse”, “upper”, “lower”, “front”, “back”, “left”, “right”, “vertical”, “horizontal”, “top”, “bottom”, “inside”, “outside” are used to describe the orientation or positional relationships based on the accompanying drawings. These terms are utilized for the convenience of expounding on the application and simplifying the description. They do not imply that the device or element must have a specific orientation, and be constructed and operated in a specific orientation. Additionally, when features are described as “first” or “second”, it does not necessarily denote a specific order or importance and may encompass one or more of such features.

Please take note that, unless otherwise clearly specified and limited, the terms “installed”, “connected”, and “linked” should be interpreted broadly. For example, they could refer to a fixed connection, a detachable connection, or an integral connection. Additionally, they could involve a mechanical or electrical connection, a direct or indirect connection through an intermediate medium, or the internal connection of two components. The specific meanings of these terms in this application can be understood according to specific circumstances by ordinary technicians in this field.

The technical solution of the present application is further described below with reference to the accompanying drawings of FIG. 1 to FIG. 6 and through specific implementation methods.

As shown in FIG. 1-6, a 3D printing consumables drying machine, comprising a base 1, a rolling mechanism 2, a heating mechanism, an upper cover 3, a drive mechanism 4 and a reel 5.

The top of the base 1 is provided with a accommodation cavity 11. Wherein the accommodation cavity 11 is provided with a clapboard 12;

The rolling mechanism 2 is installed in the accommodating cavity 11. The rolling mechanism 2 is used to carry the reel 5.

The heating mechanism is installed in the accommodating cavity 11. Wherein the heating mechanism is used to heat and dry the consumables on the reel 5.

The driving mechanism 4 is installed in the accommodating cavity 11. Wherein the driving mechanism 4 is used to drive the rolling mechanism 2 to rotate and to drive the reel 5 on the rolling mechanism 2 to rotate.

The top of the base 1 is provided with an upper cover 3. The bottom surface of the upper cover 3 is open. The rolling mechanism 2, the heating mechanism and the driving mechanism 4 are all located directly below the upper cover 3.

It can be understood that in this solution, the driving mechanism 4 is provided to drive the rolling mechanism 2 to rotate to drive the reel 5 on the rolling mechanism 2 to rotate, so that the consumables on the reel 5 can be heated evenly, avoiding uneven heating and local overheating of the consumables during drying.

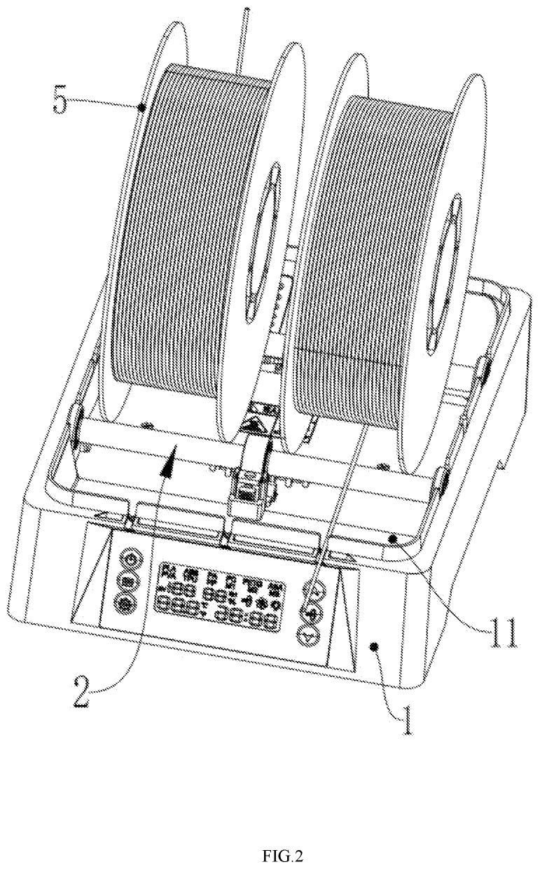

As shown in FIG. 2-FIG. 4, the rolling mechanism 2, comprising a first roller set 21. Wherein the first roller set 21, comprising a first roller 211 and a second roller 212 in the accommodation cavity 11. Wherein the first roller 211 and the second roller 212 are arranged parallel to and spaced apart from each other.

The drive mechanism 4, comprising a drive component 41. The driving component 41 is installed at the bottom end of the accommodating cavity 11. The output end of the driving component 41 is connected to a first bevel gear 42. The upper portion of the first bevel gear 42 is meshedly connected with a second bevel gear 43. The second bevel gear 43 is coaxially connected to a rotating shaft 44. Wherein cams 46 are fixedly connected at both ends of the rotating shaft 44. The outer circumference of the cam 46 is fixedly sleeved with an anti-slip ring 45. The raised ends of the two anti-slip rings 45 are in contact with the outer surface of the first roller 211.

It can be understood that in this solution, the driving component 41 rotates the first bevel gear 42, which in turn rotates the meshing second bevel gear 43, causing the rotating shaft 44 to rotate. As the rotating shaft 44 turns, it also rotates the cams 46 at both ends. When the raised end of the cam 46 reaches the low point, the anti-slip ring 45 is not in contact with the first roller 211. In this state, the first roller 211 operates independently and is not influenced by the driving mechanism 4. When the raised end of the cam 46 reaches the high point, the anti-slip ring 45 comes into contact with the first roller 211. At this point, the first roller 211 is driven to rotate due to the friction force of the anti-slip ring 45, thereby causing the reel 5 to rotate intermittently between the first roller 211 and the second roller 212.

As shown in FIG. 2-FIG. 4, the rolling mechanism 2, comprising a second roller set 22. Wherein the second roller set 22, comprising a third roller 221 and a fourth roller 222 rotatably disposed in the accommodating cavity 11. The axes of the third roller 221 and the first roller 211 are located on the same straight line. Wherein axes of the fourth roller 222 and the second roller 212 are located on the same straight line.

The protruding ends of the two anti-slip rings 45 are in contact with the outer surfaces of the first roller 211 and the third roller 221 respectively.

When the user utilizes consumables, the printer's feed will cause reel 5 to rotate. During this process, reel 5 must rotate without being influenced by the driving mechanism 4. If not, reel 5 will rotate out of sync, causing printing to become uneven. To prevent this issue, the only action required during printing is to engage driving member 41 to rotate the anti-slip ring 45 so that it does not touch the first roller 211 and the third roller. After that, the driving mechanism 4 can be disengaged. This allows reel 5 to move freely without affecting the position of the driving mechanism 4, ensuring smooth printer feeding.

To prevent the reel 5 from getting stuck or tangled during printing, the drive mechanism 4 is equipped with a function that allows the reel to rotate forward 1-2 times and then reverse 1-2 times, intermittently rotating forward and reverse. This helps to avoid issues with the filament such as knotting and entanglement, ensuring smooth printing.

Preferably, the driving member 41 is a reduction motor, which has a large torque and a low speed. The optimal speed of the reduction motor is 10 to 50 revolutions per minute, so that the reel can finally rotate slowly to avoid the reel 5 slipping on the first roller 211 and the third roller due to too high a speed.

As shown in FIG. 2-FIG. 4, the end of the third roller 221 and the first roller 211 that is away from each other and the end of the fourth roller 222 and the second roller 212 that is away from each other are both rotatably connected to a first bearing base 23. The first bearing base 23 is fixedly mounted on the side wall of the accommodating cavity 11. The third roller 221 and the first roller 211, which are adjacent to each other, and the fourth roller 222 and the second roller 212, which are also adjacent to each other, are both connected to a second bearing base in a way that allows them to rotate. The outer surfaces of each of the two adjacent second bearing bases are fixedly sleeved with a fixed base 24. Wherein the fixed base 24 is fixedly mounted on the clapboard 12. The rotating shaft 44 is disposed through the fixed base 24 and is rotatably connected to the fixed base 24.

It is understandable that by setting the first bearing base 23 and the second bearing base, the coaxial third roller 221 and the first roller 211 can rotate independently without interfering with each other, so that the device can be adapted to place a reel 5 with a larger width, and can also be adapted to place two reels 5 of conventional size.

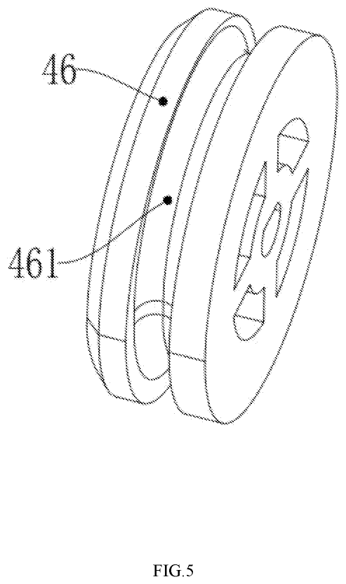

As shown in FIG. 5, the outer circumference of the cam 46 is provided with a groove 461. Wherein the anti-slip ring 45 is embedded in the groove 461.

It is understandable that groove 461 can be provided to stably mount the anti-slip ring 45 on the cam 46, thereby preventing the anti-slip ring 45 from being offset.

As shown in FIG. 1-FIG. 3, the top of the clapboard 12 is provided with a temperature sensor and a humidity sensor. Wherein the side wall of the base 1 is provided with a control panel 13. The control panel 13 is connected to the driving component 41 via a wire. The temperature sensor and the humidity sensor are electrically connected.

It is understandable that the temperature and humidity conditions inside the device can be monitored in real-time by the temperature sensor and humidity sensor (not shown in the figure), and displayed on the control panel 13. The control panel 13 can also control the rotation of the reel 5, and set the baking temperature, drying time, heating power, etc., so as to facilitate the user's operation.

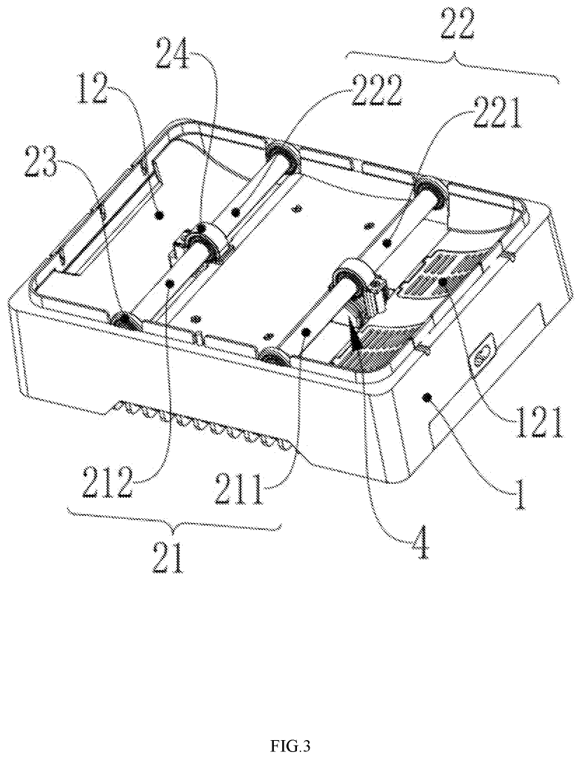

As shown in FIG. 3, the surface of the clapboard 12 is provided with a desiccant tank 121 and a through hole. The driving mechanism 4 is located in the through hole.

The desiccant tank 121 can be used to place desiccant inside. When the device is not baked, the desiccant can absorb water molecules in the air, thereby making the internal environment of the device drier.

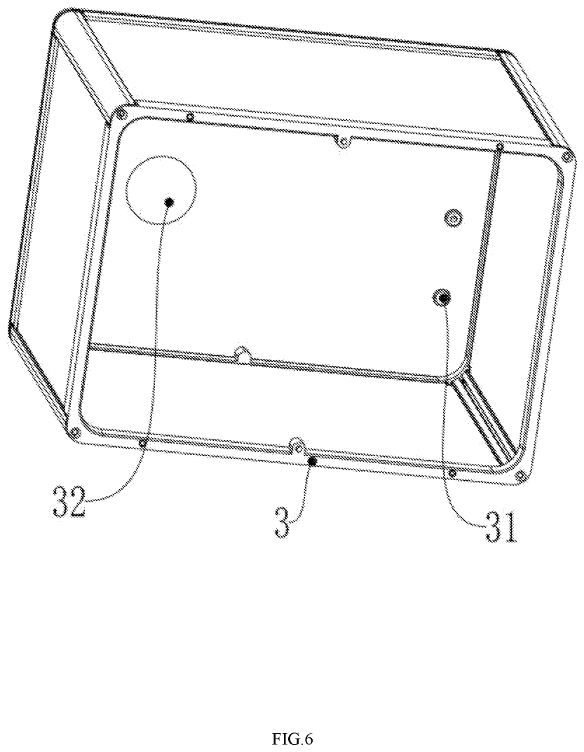

As shown in FIGS. 1 and 6, the top of the upper cover 3 and the side wall of the base 1 are both provided with a outlet hole 31. The top of the upper cover 3 is also provided with an exhaust vent 32.

The outlet hole 31 is provided to facilitate the user to take out the consumable wires in the device, and the exhaust vent 32 is provided to allow the hot air flow to carry water molecules out from the exhaust vent 32, thereby achieving the effect of rapid drying.

An exhaust valve may be installed in the exhaust vent 32. The exhaust valve may be used to open and close the exhaust vent 32 and adjust the size of the exhaust vent 32. When not baking, closing the exhaust vent 32 by the exhaust valve may make the device more airtight to prevent water vapor from entering the device. When baking, the exhaust valve may be opened to open the exhaust vent 32 to allow convection of hot air inside the device, thereby quickly and efficiently discharging the moisture produced by baking out of the cavity.

As shown in FIG. 1, the upper cover is transparent or translucent; wherein a handle 33 is provided at the top of the upper cover 3.

The upper cover is set to be transparent or translucent so that the user can more intuitively see the baking situation inside the device and the remaining amount of consumables on the reel 5. The handle 33 is set to facilitate the user to open the upper cover 3 with one hand when in use.

As shown in FIG. 1, the bottom of the base 1 is provided with anti-slip pads around the periphery.

The anti-slip pad (not shown in the figure) can prevent the wire dragging device from sliding during printing.

1. A 3D printing consumables drying machine, comprising a base, a rolling mechanism, a heating mechanism, an upper cover, a drive mechanism and a reel;
wherein the top of the base is provided with an accommodation cavity; wherein the accommodation cavity is provided with a clapboard;
wherein the rolling mechanism is installed in the accommodating cavity; the rolling mechanism is used to carry the reel; wherein the heating mechanism is installed in the accommodating cavity; wherein the heating mechanism is used to heat and dry the consumables on the reel;
wherein the driving mechanism is installed in the accommodating cavity; wherein the driving mechanism is used to drive the rolling mechanism to rotate and to drive the reel on the rolling mechanism to rotate;
wherein the top of the base is provided with an upper cover; the bottom surface of the upper cover is open; wherein the rolling mechanism, the heating mechanism and the driving mechanism are all located directly below the upper cover.

2. The 3D printing consumables drying machine of claim 1, wherein the rolling mechanism, comprising a first roller set; wherein the first roller set, comprising a first roller and a second roller in the accommodation cavity; wherein the first roller and the second roller are arranged parallel to and spaced apart from each other;
wherein the drive mechanism, comprising a drive component; wherein the driving component is installed at the bottom end of the accommodating cavity; wherein the output end of the driving component is connected to a first bevel gear; wherein the upper portion of the first bevel gear is meshedly connected with a second bevel gear; wherein the second bevel gear is coaxially connected to a rotating shaft; wherein cams are fixedly connected at both ends of the rotating shaft; wherein the outer circumference of the cam is fixedly sleeved with an anti-slip ring; wherein the raised ends of the two anti-slip rings are in contact with the outer surface of the first roller.

3. The 3D printing consumables drying machine of claim 1, wherein the rolling mechanism, comprising a second roller set; wherein the second roller set, comprising a third roller and a fourth roller rotatably disposed in the accommodating cavity; wherein the axes of the third roller and the first roller are located on the same straight line; wherein axes of the fourth roller and the second roller are located on the same straight line;
wherein the protruding ends of the two anti-slip rings are in contact with the outer surfaces of the first roller and the third roller respectively.

4. The 3D printing consumables drying machine of claim 1, wherein the end of the third roller and the first roller that is away from each other and the end of the fourth roller and the second roller that is away from each other are both rotatably connected to a first bearing seat; wherein the first bearing base is fixedly mounted on the side wall of the accommodating cavity; wherein the third roller and the first roller, which are adjacent to each other, and the fourth roller and the second roller, which are also adjacent to each other, are both connected to a second bearing seat in a way that allows them to rotate; wherein the outer surfaces of each of the two adjacent second bearing bases are fixedly sleeved with a fixing base; wherein the fixing base is fixedly mounted on the clapboard; wherein the rotating shaft is disposed through the fixed base and is rotatably connected to the fixed base.

5. The 3D printing consumables drying machine of claim 2, wherein the outer circumference of the cam is provided with a groove; wherein the anti-slip ring is embedded in the groove.

6. The 3D printing consumables drying machine of claim 2, wherein the top of the clapboard is provided with a temperature sensor and a humidity sensor; wherein the side wall of the base is provided with a control panel; wherein the control panel is connected to the driving component via a wire; wherein the temperature sensor and the humidity sensor are electrically connected.

7. The 3D printing consumables drying machine of claim 1, wherein the surface of the clapboard is provided with a desiccant tank and a through hole; wherein the driving mechanism is located in the through hole.

8. The 3D printing consumables drying machine of claim 1, wherein the top of the upper cover and the side wall of the base are both provided with an outlet hole; wherein the top of the upper cover is also provided with an exhaust vent.

9. The 3D printing consumables drying machine of claim 1, wherein the upper cover is transparent or translucent; wherein a handle is provided at the top of the upper cover.

10. The 3D printing consumables drying machine of claim 1, wherein the bottom of the base is provided with anti-slip pads around the periphery.
